(19) United States
(12) Patent Application Publication
(10) Pub. No.: US 2025/0320886 A1
(43) Pub. Date: Oct. 16, 2025

(54) CROSSOVER FASTENER

(71) Applicant: PERFECTVISION MANUFACTURING, INC., Little Rock, AR (US)

(72) Inventors: Scott Stekr, Littleton, CO (US); Dominic Newnham, Centennial, CO (US); Brenton Barton, Golden, CO (US)

(21) Appl. No.: 18/633,210

(22) Filed: Apr. 11, 2024

(51) Int. Cl. F16B 7/04; H01Q 1/12

(52) U.S. Cl. CPC F16B 7/0493; H01Q 1/1228

(57) ABSTRACT

A crossover fastener for securing crossed structural arms via a bridge and clamp assembly.

### BACKGROUND OF THE INVENTION

Fasteners for fixing or anchoring one or more arms are common, having been used for hundreds of years. However, these fasteners are adapted for seemingly endless different uses and come in seemingly endless designs suited to their particular use.

One such use or class of uses has come with the advent of modern communications and wireless communications including cell phone communications. In particular, the last 40 years have seen the development of signal transmission and signal reception hardware including for example antennas and antenna towers. Various fixations used with this communications hardware includes fixations for holding parts together and fixations for anchoring various parts assemblies.

### Field of Invention

This invention relates to the mechanical arts. In particular, the invention provides fixations for securing hardware associated with wireless communications, for example hardware associated with antennas, antenna towers, and communications infrastructure.

### Discussion of the Related Art

Fixations used with wireless communications hardware such as antennas and antenna towers are adapted to serve the particular needs and constraints of this hardware and its application. The design of these fixations is therefore highly dependent on the design of the hardware parts to be fixed, arrangement of these parts, and structural demands these parts place on the fixations. As such, although all such fixations serve to fix parts, the details of fixation design are controlled by, among other things, the design of the parts being fixed and the demands these parts place on their fixations.

### SUMMARY OF THE INVENTION

The present invention provides a crossover fastener and/or a crossover fastener assembly. In an embodiment a crossover fastener assembly includes first and second crossed arms; between the arms, a bridge into which the arms are fitted, the bridge for preventing a relative rotation of the first arm with respect to the second arm; the arms fixed to the bridge by a compression frame; the compression frame having opposing members for capturing the bridge and the arms therebetween; and, opposing member corners with fitments for bolts, the bolts operable to move the opposing members closer together.

In some embodiments the crossover fastener assembly bridge receives the first arm into opposed slots with openings at one end of the bridge; and, the bridge receives the second arm into opposed slots with openings at an opposite end of the bridge. In some embodiments of the crossover fastener assembly one of the compression frame members includes a web with canted web portions that join at a web centerline. In some embodiments of the crossover fastener assembly both compression frame members have a web; one of the webs being received by the opposed slots at one end of the bridge; the other of the webs being received by the opposed slots at the other end of the bridge. In some embodiments of the crossover fastener assembly each arm contacts the bridge and one of the compression frame members.

In an embodiment an assembly that includes a cell tower that supports a cellular antenna via a crossover fastener comprises: first and second crossed tower arms; a crossover fastener including a bridge and a compression frame; between the arms, the bridge into which the arms are fitted, the bridge for preventing a relative rotation of the first arm with respect to the second arm; the arms fixed to the bridge by the compression frame; the compression frame having opposing members for capturing the bridge and the arms therebetween; opposing member corners with fitments for bolts, the bolts operable to move the opposing members closer together; and, the cellular telephone antenna coupled to the tower via the first tower arm or the second tower arm.

In some embodiments of the assembly the bridge receives the first tower arm into opposed slots with openings at one end of the bridge; and, the bridge receives the second tower arm into opposed slots with openings at an opposite end of the bridge. In some embodiments of the assembly one of the compression frame members includes a web with canted web portions that join at a web centerline. In some embodiments of the assembly both compression frame members have a web; one of the webs being received by the opposed slots at one end of the bridge; the other of the webs being received by the opposed slots at the other end of the bridge. In some embodiments of the assembly each tower arm contacts the bridge and one of the compression frame members.

### BRIEF DESCRIPTION OF THE DRAWINGS

The present invention is described with reference to the accompanying figures. These figures, incorporated herein and forming part of the specification, illustrate embodiments of the present invention and, together with the description, further serve to explain the principles of the invention and to enable a person skilled in the relevant art to make and use the invention.

FIGS. 1A-B show crossed structural members in the form of a first arm crossed with a second arm having a crossover fastener located at the crossing.

FIGS. 2A-D show a yoke pieces and a bridge associated with the crossover fastener of FIG. 1A.

FIG. 3A shows an exploded view of a crossed member fixation in accordance with FIG. 1A.

FIG. 3B shows a compression frame of the crossover fastener of FIG. 1A.

FIGS. 4A-B show installed views of the crossover fastener of FIG. 1A.

FIG. 5 shows an exemplary payload and an exemplary structure for supporting the payload utilizing the crossover fastener of FIG. 1A.

### DETAILED DESCRIPTION OF THE PREFERRED EMBODIMENTS

The disclosure provided in the following pages describes examples of some embodiments of the invention. The designs, figures, and descriptions are non-limiting examples of certain embodiments of the invention. For example, other embodiments of the disclosed device may or may not include the features described herein. Moreover, disclosed advantages and benefits may apply to only certain embodiments of the invention and should not be used to limit the disclosed inventions.

As used herein, coupled means directly or indirectly connected by a suitable means known to persons of ordinary skill in the art. Coupled items may include interposed features such as, for example, A is coupled to C via B. Unless otherwise stated, the type of coupling, whether it be mechanical, electrical, fluid, optical, radiation, or other is provided by the context in which the term is used.

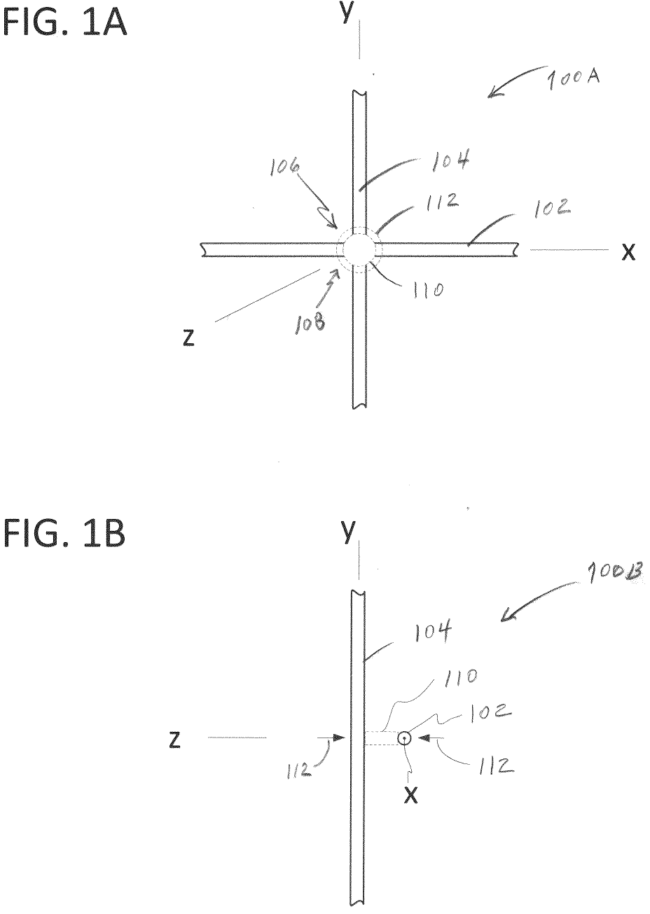

FIG. 1A shows crossed structural members (i.e., arms) 100A. Here, a first arm or crosspiece 102 along the X axis and a second arm or crosspiece 104 along the Y axis, which may be crossed at a right angle or at another angle. In the drawing, the Z axis follows the right-hand rule. One or both of the crossed arms may be made from a metal and may take the form of a hollow, partially hollow, or solid tube, strut, rod, or shaft. The arms may be straight or not.

In the vicinity of the location where the arms cross 106, there is a means for fixing the first arm to the second arm 108. This means may include or be any one or more of a clamp, a bridge, a collar, a bolted connection, a yoke, or the like.

In an embodiment, a fixation that attaches the first arm to the second arm includes or consists of a bridge 110. In an embodiment, a fixation that attaches the first arm to the second arm includes or consists of a compression frame 112. In an embodiment, a fixation that attaches the first arm to the second arm includes or consists of a bridge 110 and a compression frame 112.

FIG. 1B shows the assembly of FIG. 1A rotated about the Y axis such that the X axis appears as a point 100B. Where a bridge fixation is used, the first and second arms 102, 104 are spaced apart and a bridge such as a bridge between the arms 110 provides fixation. Where a compression frame fixation is used, the first and second arms are fixed together by the compression frame 112. Where both a bridge and a compression frame are used, the compression frame presses the first and second arms against the bridge.

In various embodiments, the term crossover fastener assembly includes a bridge and a compression frame. In various embodiments, the term crossover fastener assembly includes a bridge, compression frame, and crossed arms.

In various embodiments, the bridge may prevent a relative rotation of a first arm with respect to a second arm.

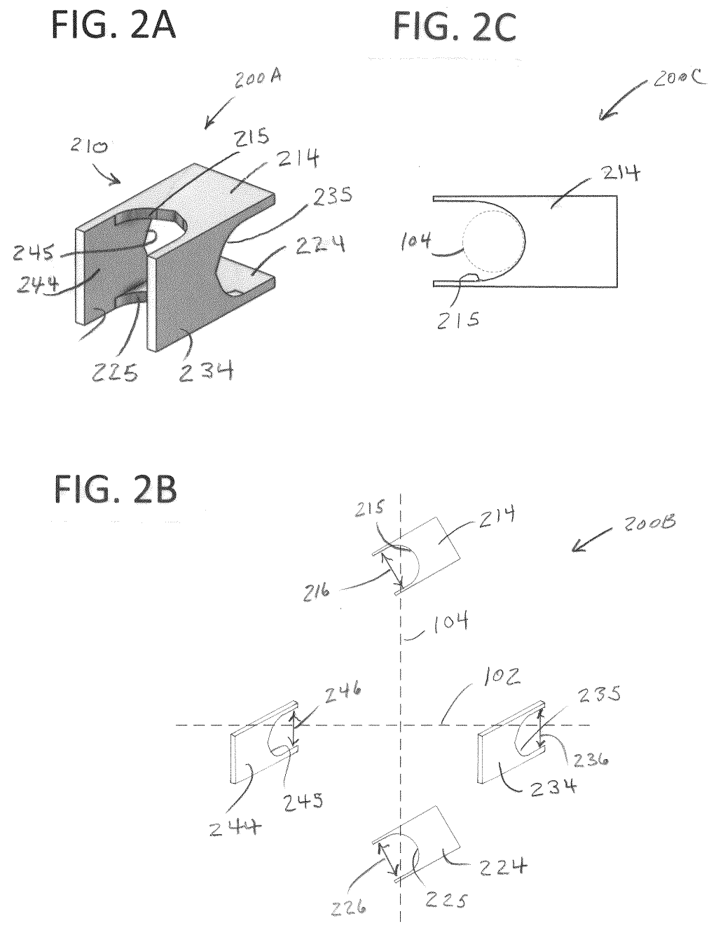

FIG. 2A shows another embodiment of a bridge 200A. As shown, the bridge has four sides in the form of yoke pieces 214, 224, 234, 244. Each yoke piece has a throat such as a semi-circular opening at one end 214/215, 224/225, 234/235, 244/245.

FIG. 2B shows a bridge exploded view 200B. Here yoke piece circular openings 215, 225 are opposite one another and yoke piece semi-circular openings 235, 245 are opposite one another, the openings 215, 225 being opposite the openings 235, 245. In each yoke piece, a yoke piece opening or throat 214/216, 224/226, 234/236, 244/246 provides an entry point for one of the arms or an arm portion.

FIG. 2C shows a typical yoke piece 214 200C. As seen, an arm or crosspiece 104 is fitted into the yoke piece semi-circular opening 215. In some embodiments, the arm or crosspiece is seated in the semi-circular opening. In some embodiments, the arm contacts the semi-circular opening with point contact, multiple point contact or continuous contact. The contact may extend through an angle of about 5 to 180 degrees. In various embodiments, the arm may be fixed or not to the bridge. Fixations include fixations via adhesive, weldment, fasteners, or the like.

FIG. 2D shows a cross-section 200D of the bridge of FIG. 2A. As seen, there are upper and lower cross-sections of yoke pieces 214a, 224a and lateral cross-sections of yoke pieces 234a, 244a. As shown here, the side yoke pieces 234 and 244 may be fitted between the upper and lower yoke pieces 214 and 224. In another embodiment, the upper and lower yoke pieces may be fitted between the lateral yoke pieces.

The bridge 210 may be machined or formed from one or multiple workpieces such as metal workpieces. The bridge yoke pieces 214-244 may be the same or different shapes and multiple yoke pieces may be welded or otherwise connected together to form the bridge.

In various embodiments, one or more clamps are used to fix arms such as arms 102, 104 to the bridge 110. For example, the arms may be fixed in a bridge via a clamp or compression frame having opposing members that are pulled together to force the arms into the bridge, for example to force the arms into contact with the bridge semi-circles.

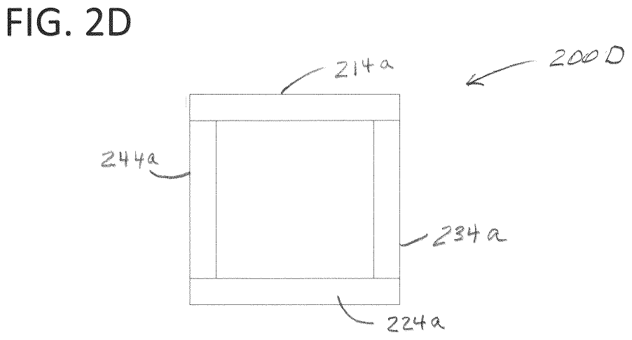

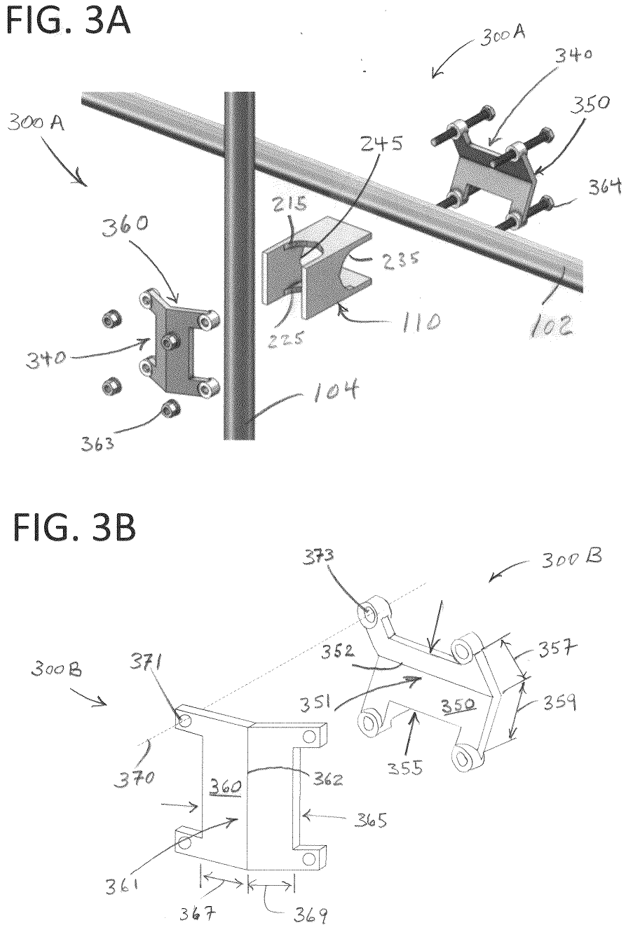

FIG. 3A shows an exploded view of a crossed member fixation 300A. Here, a bridge interconnects the crossed members and a clamp fixes the crossed members to the bridge.

In particular, arm 104 is for insertion into bridge semi-circles 215, 225 and arm 102 is for insertion into bridge semi-circles 235, 245. The arms are fixed in the bridge via a clamp or compression frame 340. The clamp has opposing members 350, 360 that are pulled together for example by bolts 364 and nuts 363 to force the arms into the bridge 110, for example to force the arms into contact with the bridge semi-circles.

FIG. 3B shows an exploded view of an exemplary somewhat rectangular clamp or compression frame 300B. Here, a first opposing member 350 has a web 351 which may have canted web portions 357, 359 that join at a web centerline 352. Corners of the clamp such as corner 373 provide for attachment of the first opposing member 350 to the second opposing member 360. Notably, the web or a portion thereof and its centerline 352 may be inserted into the slots 235, 245 whereby the arm 102 is captured between the bridge 110 and the first opposing member 350.

Further, a second opposing member 360 has a web 361 which may have canted web portions 367, 369 that join at a web centerline 362. In some embodiments the centerlines 352 and 362 are crossed. The centerlines 352 and 362 may cross forming a right angle. Corners of the clamp such as corner 371 provide for attachment of the second opposing member 360 to the first opposing member 350. Notably, the web or a portion thereof and its centerline 362 may be inserted into the slots 215, 225 whereby the arm 104 is captured between the bridge 110 and the second opposing member 360.

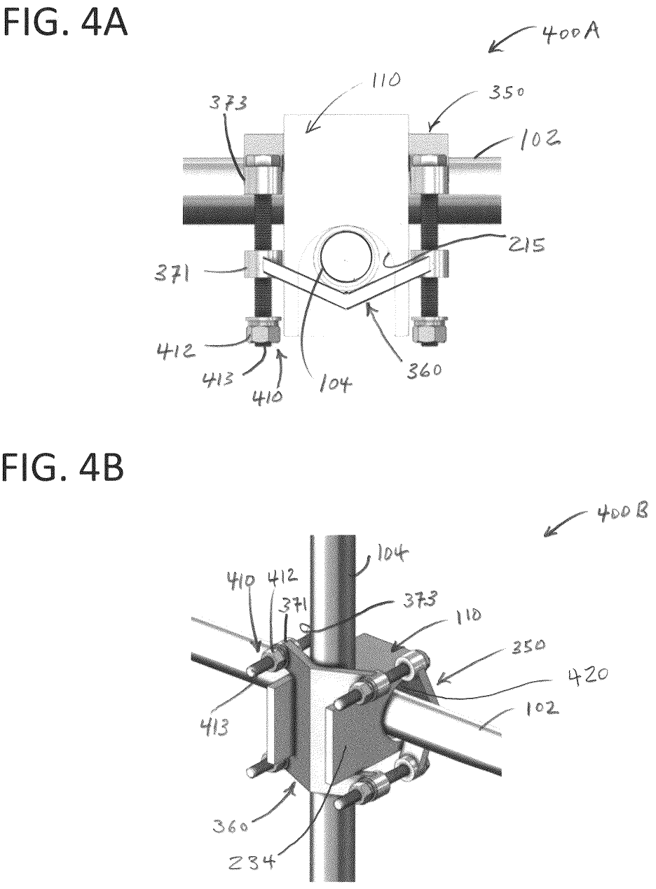

FIG. 4A shows an installed top view of a crossover fastener similar to the above 400A. Arms 102 and 104 are shown crossed at right angles, each of the arms being seated in a bridge 110. First and second opposing members 350, 360 form a compression frame or clamp for connecting the arms directly or indirectly to the bridge. Thru bolts at opposing member corners are used to pull the opposing members together, for example fasteners 410 such as bolt 413 passing along line 370 through corner holes 371, 373 with a tightening nut 412.

FIG. 4B shows an installed isometric view of a crossover fastener similar to the above 400B. Here, arms 102 and 104 are inserted in the bridge 110 and into semicircular portions of bridge slots such as semicircular portion 420 of the slot 235 in yoke piece 234. First and second opposing members 350, 360 form a compression frame or clamp for connecting the arms directly or indirectly to the bridge. Thru bolts at opposing member corners are used to pull the opposing members together, for example fasteners 410 such as bolt 413 passing through corner holes 371, 373 with a tightening nut 412.

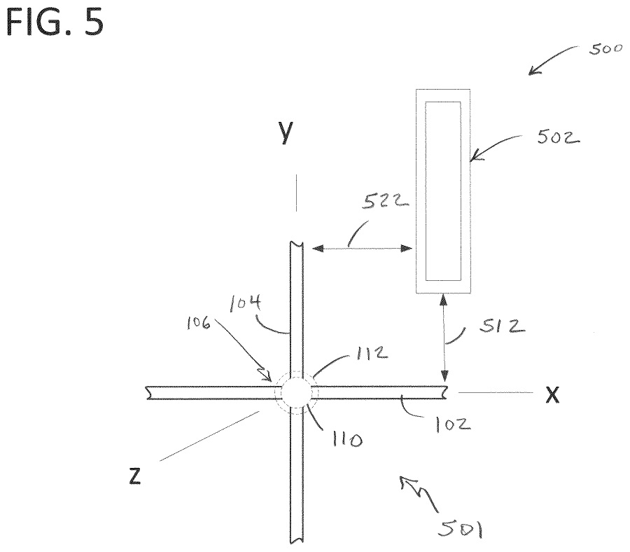

FIG. 5 shows an exemplary payload 502 and an exemplary structure for supporting the payload 500. The payload 502 may be: any of a package, an electronics package, electronic equipment, an antenna, a cellular telephone antenna, a cellular telephone tower antenna, or a package supported by a cellular telephone tower. The structure 501 may be: any of a structure/substructure, a vertical structure/substructure, a tower, or a horizontal structure/substructure. Antennas and the like may be for communications such as cell phone communications and/or broadband communications.

The structure 501 includes crossed structural members (i.e., arms), a first arm or crosspiece 102 along the X axis and a second arm or crosspiece 104 along the Y axis, which may be crossed at a right angle or at another angle. In the drawing, the Z axis follows the right-hand rule. One or both of the crossed arms may be made from a metal and may take the form of a hollow, partially hollow, or solid tube, strut, rod, or shaft. The arms may be straight or not.

In the vicinity of the location where the arms cross 106, there is a means for fixing the first arm to the second arm 108. This arm fixing means may include any one or more of a clamp, a bridge, a collar, a bolted connection, a yoke, or the like.

In an embodiment, a fixation that attaches the first arm to the second arm includes or consists of a bridge 110. In an embodiment, a fixation that attaches the first arm to the second arm includes or consists of a compression frame 112. In an embodiment, a fixation that attaches the first arm to the second arm includes or consists of a bridge 110 and a compression frame 112.

In some embodiments, the structure 501 supports a cellular telephone antenna 502 such as a cellular telephone antenna supported by a cellular telephone tower. The cellular telephone antenna may be an elongated antenna oriented vertically. Linkages used to interconnect the tower and the antenna may include first dimension linkages such as a vertical or somewhat vertical linkage 512 between the antenna and a horizontal or somewhat horizontal arm 102. Linkages used to interconnect the tower and the antenna may include second dimension linkages as a horizontal linkage 522 between the antenna and a somewhat vertical arm 104. In various embodiments, the linkages may connect directly to the front, back, or side of the antenna. In various embodiments, the linkages may connect to fixtures, aiming features/appurtenances (azimuth, elevation, direction, etc. . . . ), or the like that are used with the antenna.

While various embodiments of the present invention have been described above, it should be understood that they have been presented by way of example only, and not limitation. It will be apparent to those skilled in the art that various changes in the form and details can be made without departing from the spirit and scope of the invention. As such, the breadth and scope of the present invention should not be limited by the above-described exemplary embodiments, but should be defined only in accordance with the following claims and equivalents thereof.

What is claimed is:

1. A crossover fastener assembly comprising:
first and second crossed arms;
between the arms, a bridge into which the arms are fitted, the bridge for preventing a relative rotation of the first arm with respect to the second arm;
the arms fixed to the bridge by a compression frame;
the compression frame having opposing members for capturing the bridge and the arms therebetween; and,
opposing member corners with fitments for bolts, the bolts operable to move the opposing members closer together.

2. The crossover fastener assembly of claim 1 wherein:
the bridge receives the first arm into opposed slots with openings at one end of the bridge; and,
the bridge receives the second arm into opposed slots with openings at an opposite end of the bridge.

3. The crossover fastener assembly of claim 2 wherein one of the compression frame members includes a web with canted web portions that join at a web centerline.

4. The crossover fastener assembly of claim 3 wherein:
both compression frame members have a web;
one of the webs being received by the opposed slots at one end of the bridge;
the other of the webs being received by the opposed slots at the other end of the bridge.

5. The crossover fastener of claim 4 wherein various sizes or diameters of one of the arms are accommodated when one of the webs fits inside a pair of the bridge slots.

6. The crossover fastener assembly of claim 4 wherein each arm contacts the bridge and one of the compression frame members.

7. An assembly that includes a cell tower that supports a cellular telephone antenna via a crossover fastener comprising:
first and second crossed tower arms;
a crossover fastener including a bridge and a compression frame;
between the arms, the bridge into which the arms are fitted, the bridge for preventing a relative rotation of the first arm with respect to the second arm;
the arms fixed to the bridge by the compression frame;
the compression frame having opposing members for capturing the bridge and the arms therebetween;
opposing member corners with fitments for bolts, the bolts operable to move the opposing members closer together; and,
the cellular telephone antenna coupled to the tower via the first tower arm or the second tower arm.

8. The assembly of claim 7 wherein:
the bridge receives the first tower arm into opposed slots with openings at one end of the bridge; and,
the bridge receives the second tower arm into opposed slots with openings at an opposite end of the bridge.

9. The assembly of claim 8 wherein one of the compression frame members includes a web with canted web portions that join at a web centerline.

10. The assembly of claim 8 wherein:
both compression frame members have a web;
one of the webs being received by the opposed slots at one end of the bridge;
the other of the webs being received by the opposed slots at the other end of the bridge.

11. The assembly of claim 10 wherein each tower arm contacts the bridge and one of the compression frame members.
